(19) United States
(12) Patent Application Publication
(10) Pub. No.: US 2003/0172724 A1
(43) Pub. Date: Sep. 18, 2003

(54) Liquid chromatography column distributor

(75) Inventors: Miroslav Petro, San Jose, CA (US); Son Hoai Nguyen, Santa Clara, CA (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Symyx Technologies, Inc.

(21) Appl. No.: 10/099,452

(22) Filed: Mar. 15, 2002

(51) Int. Cl. G01N 30/00

(52) U.S. Cl. 73/61.52

(57) ABSTRACT

A liquid chromatography column distributor spreads liquid over the internal cross sectional area of the column to facilitate separation of the liquid in the column into its constituent components for analysis, particularly where the volume of liquid is small and the rate of flow through the column is high. The distributor is useful for small volumes, less than 100 micro liters. The distribution is preferably done in two or more stages by two or more plates arranged in series. This arrangement keeps the flow paths short and volumes of channels in the plate carrying the liquid small. The distributor may be used in a high performance liquid chromatography (HPLC) in which liquid flows at high rates through the column. The distributor is constructed to protect the liquid sample from damage.

### BACKGROUND OF THE INVENTION

This invention relates generally to handling of liquid samples, and more particularly to a distributor for distributing a liquid sample over an area for liquid chromatography.

Liquid chromatography is well known in the art for characterizing properties of liquid samples. In general, liquid chromatography involves the separation of one or more components of a liquid sample by selective adsorption, partitioning, ion exchange, size exclusion or other techniques. Typically, the components of a sample are separated by passing a liquid mobile phase containing the sample through or across a solid stationary phase, e.g. a “packing” in a chromatographic column. For example, in size exclusion chromatography, separation is achieved by the differential exclusion or inclusion within the pores of porous packing particles, of the sample molecules as the mobile phase moves past the stationary phase. The separation causes the components of the sample to move through the column at different rates; thus, the components exit the column at different times, which allows the separated components to be characterized, for example, with a flow-through detector.

Approaches for liquid chromatography can vary with respect to the basis of separation and the basis of detection. For example, liquid chromatography can generally be characterized as either preparative chromatography or analytical chromatography. As used herein, the terms preparative chromatography and analytical chromatography are meant to have their normal meanings within the art of liquid chromatography. As such, preparative chromatography involves the high capacity purification or isolation of impurities in a sample, typically a biological sample, prior to using the sample for further analysis or another technique. On the other hand, analytical chromatography involves separating the components of a pure sample for the identification and determination of the percentage composition of the constituents of the sample (i.e., quantitative analysis) or other characterizing properties such as molecular weight, mass, particle size or conversion.

The present invention has particular, although not exclusive application for use in analytical chromatography, and in particular, high speed analytical chromatography such as that used in combinatorial chemistry methods. Combinatorial chemistry refers generally to the methods for synthesizing a collection of chemically diverse material and rapidly testing or screening the collection for desirable performance characteristics and properties. A detailed discussion of a particular application of combinatorial chemistry (including liquid chromatographic analysis) to polymer science may be found in co-assigned U.S. Pat. No. 6,260,407, the disclosure of which is incorporated herein by reference.

Combinatorial chemistry requires in its best application that the samples be characterized as quickly as possible. The impact on the liquid chromatography side of such a process is that samples need to be moved as rapidly as possible through one or more chromatographic columns and detectors. However, the column must still be able to perform its separation function, and the detector must have a minimum quantity of liquid in order to detect the characteristic or property of the liquid. To reduce the amount of time it takes the liquid sample to pass through the column, the column is made short. However in order to have sufficient volume, the column has a relatively large diameter with respect to the volume of the liquid sample.

A typical chromatographic column generally comprises a tube having an internal separation material or “packing” as the stationary phase, which acts to separate the components of the sample in the mobile phase. To ensure adequate separation, it is important that the mobile phase be equally distributed across the stationary phase. Thus, the liquid sample must be spread out over substantially the full internal cross sectional area of the column. Absent adequate distribution of the liquid sample volume at the top or entry point of the column, the mobile phase may tend to channel inside the column. As a result, components of the sample are not sufficiently separated, resulting in the detection of broad adsorption bands which make the characterization of individual components or properties of the sample difficult or impossible.

Accordingly, it is known to provide distributors which receive the liquid sample from a relatively small diameter capillary entering the column and spread it out over the internal cross sectional area of the column before entering the packing. The distributor may take the form of a plate having channels extending to numerous outlet ports extending from the channels through the plate to the other side. In order to achieve the necessary distribution the outlet ports are arranged over an area substantially equal to the internal cross sectional area of the column. The channels must be of a certain minimum length and have a certain minimum volume to reach those outlet ports. If the volume of the liquid sample plug within the mobile phase is less than the total volume of the channels in the distributor, the distribution of sample will tend to be non-uniform, i.e., more of the sample will flow to some outlet ports than to others.

### SUMMARY OF THE INVENTION

Among the several objects and features of the present invention may be noted the provision of a distributor for use in a chromatographic column which uniformly distributes liquid samples of small volumes over the internal cross sectional area of the column; the provision of such a distributor which distributes the liquid over an area which is large in proportion to the volume of the sample; the provision of such a distributor which can operate at high flow rates without damaging the liquid in the sample; the provision of such a distributor which distributes the liquid sample in multiple stages; and the provision of a liquid chromatographic column and a liquid chromatography system employing such a distributor.

In one aspect of the present invention, a chromatographic column comprises a tube having first and second open ends and packing disposed in the tube and substantially filling the tube between the ends. First and second closures located at the first and second ends of the tube, respectively, have passages for receiving a sample volume of liquid therethrough. A distributor is located in the tube generally adjacent to the first closure and between the passage in the first closure and the packing at the first end. The distributor includes a first member disposed to receive liquid from the passage of the first closure and having channels and outlet ports therein. A second member disposed between the first member and the packing for receiving liquid from the outlets of the first member has channels and outlet ports therein. The number of outlet ports in the second member is greater than the number of outlet ports in the first member so that liquid of a liquid sample is distributed over a wider area into the packing. The channels in the second member being arranged to direct liquid from the outlet ports of the first member to the outlet ports of the second member.

In another aspect of the present invention, a liquid distributor for use in distributing a small sample volume of liquid over an area in a chromatographic column comprises a first thin, flat plate having multiple channels and outlet ports therein. The channels extend across the first plate to the outlet ports for delivering the sample volume to the outlet ports. A second thin, flat plate has channels and outlet ports therein. The number of outlet ports in the second plate being greater than the number of outlet ports in the first plate so that liquid of the liquid sample is distributed over a wider area into the packing. The channels in the second plate are arranged to direct liquid from the outlet ports of the first plate to the outlet ports of the second plate.

In still another aspect of the invention, a liquid chromatography system for identifying at least one property of a sample liquid volume comprises a liquid delivery device for delivering a volume of a liquid sample at a selected rate. A column having packing therein for receiving the liquid sample has a distributor in the column to distribute the sample liquid volume substantially over the cross sectional area of the column. The distributor has a thin flat plate including channels and outlet ports therein. The total volume of the channels in the plate is less than about 1/20th of the volume of the liquid sample. A detector detects at least one property of liquid from the column. The liquid delivery device is adapted to move the sample liquid volume through the column at the rate of at least about 2 cm/min.

In a further aspect of the invention, a method of characterizing a liquid in a flow analysis system comprises the steps of delivering a sample liquid in a volume to a column. The sample liquid volume is conducted in channels on a surface of a thin, flat distributor plate to outlets on the plate. The channels have a total volume less than about 1/20th the sample liquid volume. The sample liquid volume is dispersed over an area within the column by the distributor plate. The liquid sample volume passes from the distributor plate into a separation medium in the column, and the effluent of the liquid sample from the column is analyzed to determine a property of the liquid sample.

Other objects and features of the present invention will be in part apparent and in part pointed out hereinafter.

### BRIEF DESCRIPTION OF THE DRAWINGS

FIG. 1 is a block diagram of a liquid chromatography system including a liquid chromatography column having distributor of the present invention;

FIG. 2A is an enlarged, fragmentary, schematic section of the column illustrating a sample plug of liquid approaching the column;

FIG. 2B is an enlarged, fragmentary, schematic section of the column illustrating the sample plug of liquid being distributed in the distributor of the column;

FIG. 2C is an enlarged, fragmentary, schematic section of the column illustrating the sample plug flowing through the column spread over substantially the full internal cross sectional diameter of the column;

FIG. 3 is an enlarged exploded view of the distributor;

FIG. 4 is a top plan view of a first member of the distributor;

FIG. 5 is a top plan view of a second member of the distributor.

Corresponding reference characters indicate corresponding parts throughout the several views of the drawings.

### DETAILED DESCRIPTION OF THE PREFERRED EMBODIMENT

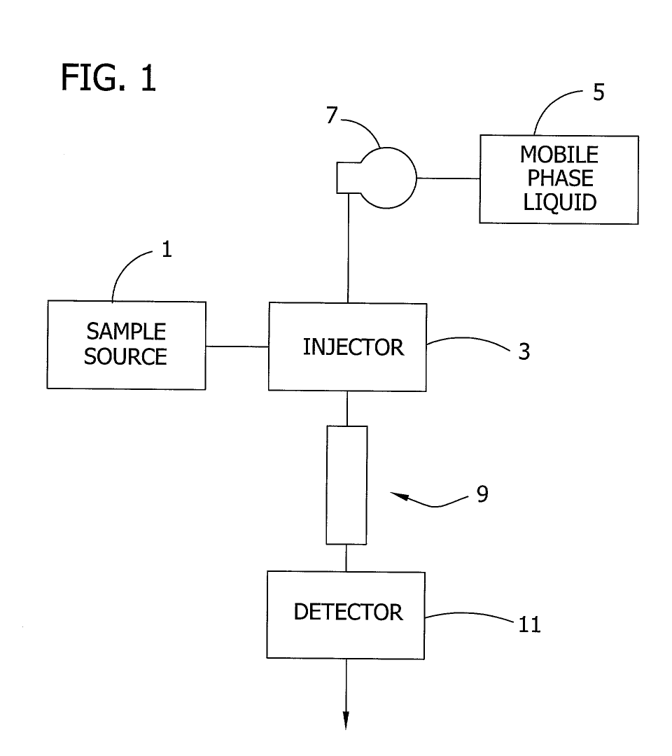

Referring now to the drawings, and in particular to FIG. 1, a liquid chromatography system is shown to include a sample source 1 from which samples of liquid to be analyzed are drawn. The sample source 1 may be sample vials, a reactor in which the samples are formed by chemical reaction, a chemical process line or may be a sample manipulator or other source for liquid samples. An injector 3 injects the samples into the flow of a mobile phase liquid supplied from a mobile phase liquid source 5 by a mover such as a pump 7 past the injector, which injects samples into the flow, and thence to a chromatographic column, indicated generally at 9. The present invention has particular, although not exclusive, application to liquid chromatography on samples of small volumetric size. More particularly, samples which are less than about 100 microliters, more preferably samples which are less than about 50 microliters and most preferably less than about 20 microliters. Sample sizes of this range are more typical of analytical liquid chromatography as distinguished from preparative chromatography. However, the present invention is not narrowly limited in application to analytical chromatography.

Preferably, the system is configured to perform high performance liquid chromatography (HPLC), in which samples are contained in a mobile phase and are moved rapidly through the system for analysis. The liquid sample is preferably moved through the column 9 at a rate of at least about 2 cm/min and more preferably at least at about 5 cm/min. In a preferred embodiment, the volume flow rate is about 1 to 50 ml/min and more preferably about 3-15 ml/min. Generally speaking the linear flow rate, which is independent of the cross sectional area of the column, is calculated by dividing the volumetric flow rate by the volume of the column and multiplying by the length. These flow rates are those encountered in HPLC for which the present invention is particularly useful. The construction, configuration and operation of the liquid chromatography system, except as further described herein, are conventional. A discussion of different exemplary techniques useful in HPLC may be found in co-assigned U.S. Pat. No. 6,260,407.

The chromatographic column separates the sample into various components in a suitable manner that is well understood by those of ordinary skill in the art. In a preferred embodiment, gel permeation chromatography (GPC), a form of size exclusion chromatography, is used. In gel permeation chromatography, the sample is separated into components according to the hydrodynamic volume occupied by each component in solution. Typically, the GPC separation medium comprises a “packing” of porous beads which receive components with molecules of lower hydrodynamic volume, thereby impeding their passage through the column 9. Components having molecules of larger diameter are not received in the pores of the packing beads and pass more rapidly through the column 9. Although not necessary or critical to the invention, the remainder of the discussion will be phrased in the context of GPC as an example of a particular chromatographic technique. However, it is to be understood that different separation media and different separation techniques may be employed without departing from the scope of the present invention. For example, reference is made to the aforementioned U.S. Pat. No. 6,260,407 for an additional discussion of the liquid chromatography system and alternative separation strategies. The system further includes a suitable flow through detection device 11 through which liquid sample exiting the column 9 passes.

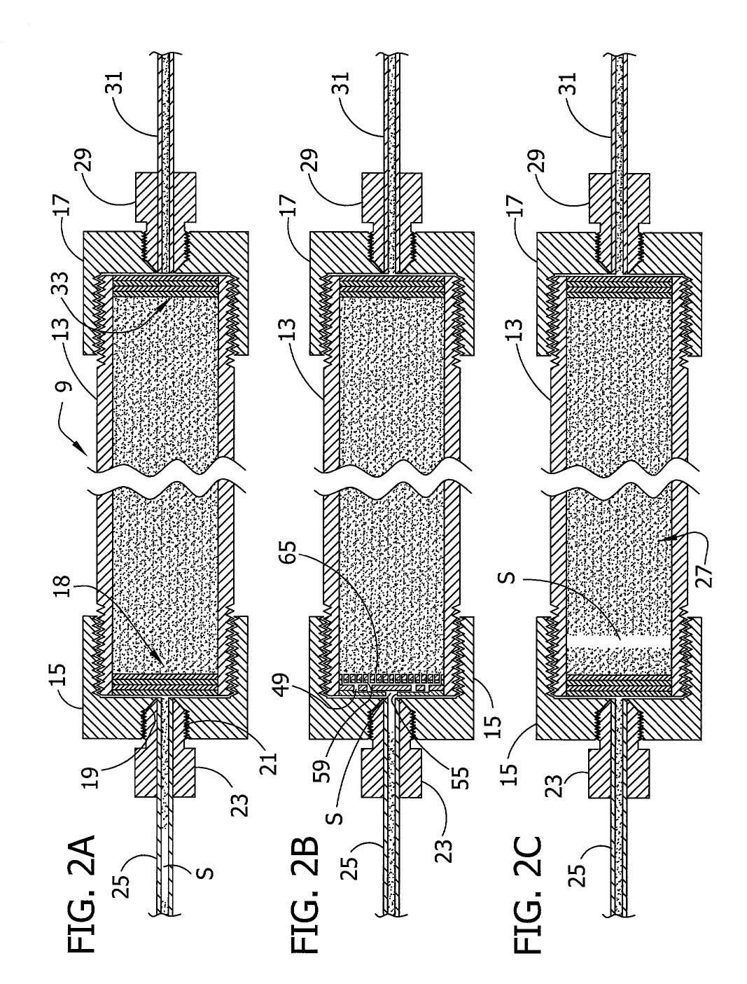

Referring now to FIG. 2A, the chromatographic column 9 is shown to comprise a cylindrical tube 13 which has open ends closed by first and second closures (designated 15 and 17, respectively) threaded onto the tube. Although the tube 13 is shown as cylindrical, tubes of other cross sectional shapes may be used. A first end of the tube 13 is further closed by a distributor constructed according to the principles of the present invention and indicated generally at 18. The tube 13 is preferably relatively wide in relation to its length as compared with traditional columns. For example, the ratio of column diameter to column height is preferably about 0.1 to 1.0. In one preferred embodiment, the diameter of the tube 13 is about 1 cm and its height is about 4.6 cm, but the exact dimensions of the tube are not narrowly critical to the present invention. The aspect ratio, defined as the ratio of width to height (e.g., D/L for right-cylindrical columns), can preferably range from about 0.3 to about 1.0, from 0.4 to about 1.0 or from about 0.5 to about 1. In some embodiments, columns having a broader range of aspect ratios can be employed in connection with distributor of the present invention. For example, the aspect ratio (e.g., D/L) can more generally range from about 0.01 to about 3.0, from about 0.05 to about 2.0, and from about 0.07 to about 1.5. The first closure 15 has a central passage 19 which threadably receives an end 21 of a fitting 23 connected to a capillary 25 extending from the injector 3 (as shown in FIG. 1) where the liquid sample is injected into the mobile phase liquid. Liquid from the capillary 25 passes from the fitting 23 to the distributor 18 located immediately adjacent to the closure and preferably engaging the end 21 of the fitting. A separation medium or packing, indicated generally at 27, in the form of porous beads fills the remaining internal volume of the tube 13. The second closure 17 is substantially identical in construction to the first closure in the illustrated embodiment. The second closure receives a fitting 29 attaching an exit flow capillary 31 to the second closure 17. A collector 33 can be located in the tube 13 between the packing 27 and the second closure 17 has the same construction as the distributor 18 (more fully described hereinafter). The collector 33 essentially works in reverse of the distributor 18 to collect the sample exiting the packing 27 into a single stream passing into the exit capillary 31. However, it is to be understood that other forms of collectors may be used. Moreover, the volume of channels (not shown) in components of the collector 33 for conducting the liquid can be larger without adversely affecting the operation of the chromatography system. It is to be understood that the collector 33 is optional and the distributor 18 can be used with or without the collector. Flow of a liquid sample S through the column 9 will be described in more detail hereinafter with reference to FIGS. 2A-2C.

Although the invention is described herein in connection with columns or tubes having a circular cross-sectional geometry, and preferably being right-cylindrical in shape, it is contemplated that the distributor of the invention may be advantageously applied in connection with other column or tube geometries as well. For example, the column or tube can have a cross-sectional geometry other than circular—such as polygonal (dodecagonal, octagonal, hexagonal, pentagonal, square, triangular, etc.). Moreover, regardless of the cross-sectional geometry (e.g., whether circular or otherwise), the cross-sectional area of the column or tube can be the same over the entirety of its length (e.g., as is the case for a right-cylindrical column), or alternatively, can vary over its length (e.g., funnel-shaped columns having a first end of relatively large circular cross-sectional area relative to its second end, or columns having a necked-down entrance portion, followed by a portion of substantially the same cross-sectional area for a lower portion of the column).

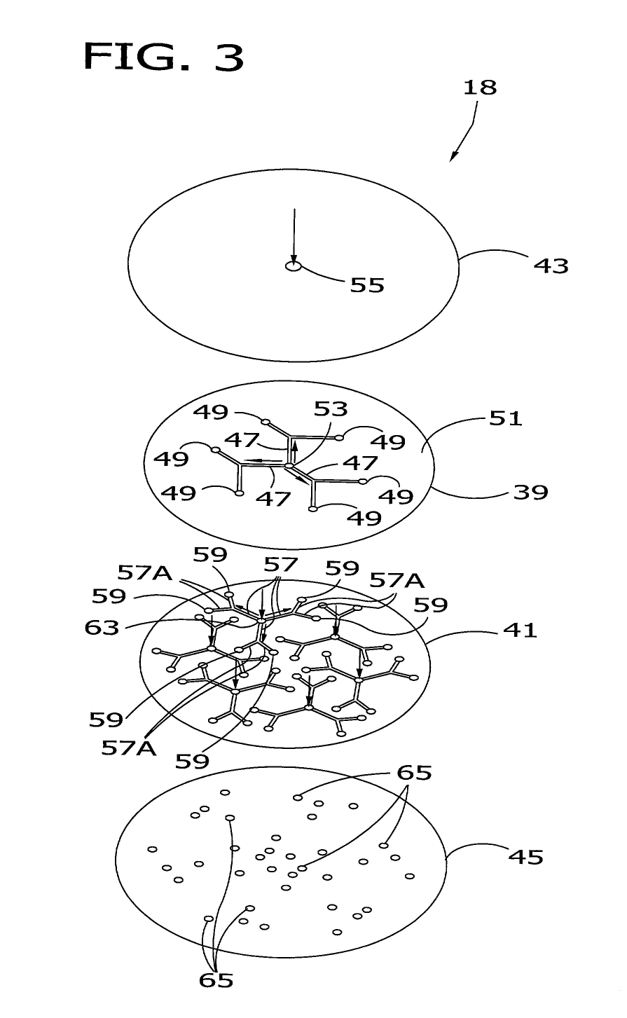

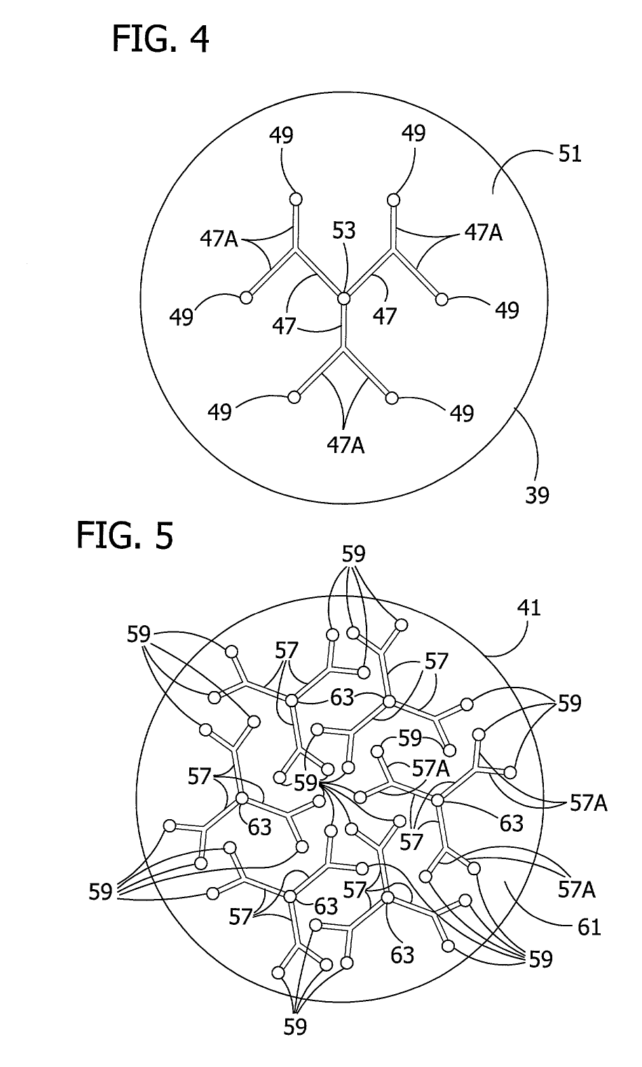

Referring now to FIG. 3, it may be seen that the distributor 18 of the illustrated embodiment comprises multiple parts which are sandwiched together in layers. That is, the distributor comprises a plurality of laminae, in integral relation to form a common body, with each of the laminae being configured and arranged relative to each other to provide multiple distribution flow paths, originating from one or more common inlets in a top surface of the first laminate, and terminating with multiple, distributed outlets in a bottom surface of a subsequent laminate (i.e.,, a second, third, fourth, fifth, etc. laminate corresponding to the number of laminates in the plurality of laminae that form the distributor). The actual number of laminates used to form the distributor is not critical, and can vary depending on the desired degree of distribution, total desired volume of the distributor flow-paths (taken cumulatively), column geometry, etc. The laminates of the distributor can be held together by pressure (e.g., compression from the closures 15 to the column 13), preferably with sealed gaskets therebetween, or alternatively, can be physically or chemically joined to each other (by appropriate fasteners or by bonding such as by anodic bonding), using techniques well know in the art of microfabrication. More specifically, as shown the distributor 18 includes a first thin, flat plate (or “member”) 39, a second thin, flat plate (or “member”) 41, an upper gasket 43 and a lower gasket 45. The first plate 39 is formed of a suitable material such as stainless steel and has channels 47 and outlet ports 49 formed in a first, upwardly directed face 51 of the plate. Because the channels 47 are small in size, quartz is another suitable material because of its ability to be micromachined. The channels 47 are generally V-shaped grooves formed in and extending along the face 51, and the outlet ports 49 extend entirely through the first plate 39, opening on the other side of the plate. The particular channel geometry is not critical to the invention, and can be selected from among many possible geometries that are known in the art of microfabrication An inlet port 53 generally in the center of the first plate 39 and can extend through the plate for manufacturing convenience. The inlet port 53 constitutes part of the channels 47. In the case where the inlet port 53 extends through the first plate 39, liquid flow through first plate 39 at the inlet port 53 is blocked by engagement with the second plate 41 so that all of the liquid sample S is passed into the channels 47. As best seen in FIG. 4, there are three channels 47 extending from the inlet port 53, each including two branches 47A at its outer end terminating at respective outlet ports 49. Thus, it may be seen that from a single entry location (inlet port 53), liquid is distributed to multiple outlet ports 49, as indicated by arrows in FIG. 3. The outlet ports 49 are arranged over a first area, which is preferably markedly less than the entire surface area of the first plate 39 and confined to an annular ring. Flow paths for liquid in each channel 47 extend from the inlet port 53 to a respective outlet port 49. The length of all of the flow paths is the same. Preferably, the total resistance to flow for each of the flow paths is substantially the same, such that a sample provided at the common inlet port 53 will be distributed approximately equally, by volume or mass, to each of the respective outlet ports 49. The total flow resistance includes resistance to flow based on length, geometric factors (number of turns and angles of turns), and surface finish associated with each channel 47, among other factors. Moreover, the total volume of the channels 47 is preferably substantially less than the volume of the liquid sample S being analyzed.

The upper gasket 43 is optional, but if employed fits over and sealingly engages the first face 51 of the first plate 39 to close the channels 47 to prevent liquid in the channels from leaving the channels except through the outlet ports 49 of the first plate. In one embodiment, the upper gasket 43 is made of polytetrafluoroethylene, but may be made of any material which is sufficiently non-reactive and can form a liquid seal. The upper gasket 43 has a central opening 55 (FIG. 3) in registration with the inlet port 53 of the first plate 39 and with the end 21 of the fitting 23. The liquid sample S may flow from the fitting 23 in the central passage 19 of the first closure 15 through the upper gasket 43 and into the channels 47 of the first plate 39.

The second plate 41 is formed of a suitable material such as stainless steel or quartz, and has channels 57 and outlet ports 59 formed in a first, upwardly directed face 61 of the plate. The channels 57 are generally V-shaped grooves formed in and extending along the face 61, and the outlet ports 59 extend entirely through the plate, opening on the other side of the plate. In the illustrated embodiment, there are six inlet ports 63 aligned with respective outlet ports 49 of the first plate 39 for receiving liquid from the first plate into the channels 57 of the second plate 41. The flow of liquid from the outlet ports 49 of the first plate 39 into the inlet ports 63 of the second plate 41 are indicated by the vertically downwardly directed arrows in FIG. 3. The inlet ports 63 constitute part of the channels 57, and can extend entirely through the second plate 41, in which case liquid flow through the second plate 41 at the inlet ports 63 is blocked by engagement with the lower gasket 45. As best seen in FIG. 5, there are three channels 57 extending from each inlet port 63, each channel including two branches 57A at its outer end terminating at respective outlet ports 59. Flow of liquid in the channels 57 is indicated by arrows for one of the inlet ports 63 and connected group of outlets 59 in FIG. 3. The lower gasket 45 is optional, but if employed has one opening 65 for each of the outlet ports 59 in the second plate 41 to allow liquid to pass through the lower gasket to the packing in the column 9 (FIG. 3). The lower gasket 45 may be made of the same material as the upper gasket 43.

Thus, it may be seen that from the six inlet ports 63 in the second plate 41, liquid is distributed to 36 outlet ports 59 arranged over a second area. The second area is preferably much larger than the first area and substantially equal to the internal cross sectional area of the tube 13. Flow paths for liquid in each channel 57 extend from the inlet port 63 to a respective outlet port 59. The length of all of the flow paths is the same. Preferably, the total resistance to flow for each of the flow paths is substantially the same, such that a sample provided at the common inlet port 63 will be distributed approximately equally, by volume or mass, to each of the respective outlet ports 59. The total flow resistance includes resistance to flow based on length, geometric factors. Dividing the distribution into two or more stages, for example on the first and second plates 39, 41, respectively, allows the length and therefore volume of the channels 47, 57 to be kept low. The total volume of the channels 47, 57 of each plate 39, 41 is substantially less than the volume of the liquid sample S to be analyzed. Preferably the volume of the channels in each plate (considered independently) is less than about 1/20 of the sample volume, more preferably less than about 1/40 of the sample volume, still more preferably less than about 1/80 of the sample volume and most preferably less than about 1/100 of the sample volume. For example, the total volume of the channels 47, 57 of each plate 39, 41 is less than about 10 microliters, more preferably the volume of the channels may be less than about 1 microliter. However, still smaller volumes of 0.5 microliters or 0.1 microliters are envisioned. The precise volume of the channels may be other than described without departing from the scope of the present invention. Also, the volume of the channels 47, 57 in each plate 39, 41 is about the same, but the invention is not limited to this equality of volume.

However the cross sectional area of the individual channels 47, 57 may be kept sufficiently large enough by use of multiple plates to inhibit shearing macromolecules flowing through the channels at relative high flow rates. Macromolecules typically are present in the liquid sample when polymers are being analyzed. “Macromolecules” are molecules composed of an aggregation of hundreds or thousands of atoms. See, Hawley's Condensed Chemical Dictionary 684 (14th ed., Richard J. Lewis, Sr. ed., 2001). It is to be understood that although two plates 39, 41 are shown, a greater number of plates may be used to further multiply the number of outlet ports discharging liquid into the packing. Moreover, the use of a single plate (not shown) is contemplated. Hence, although described herein in detail as a two-laminate configuration, the distributor can comprise larger numbers of laminae, including three or more, four or more, five or more or six or more laminate, held together to form an integral, multi-laminate body as described above. Moreover, the particular configuration of the flow paths is not critical, and is not limiting on the invention. In general, the number of common inlet ports on the first surface of the first laminate can be one or more, and is preferably one common inlet port, adapted for fluid communication with the capillary (or other tubing) of the chromatographic system. The number of outlet ports associated with each particular laminate is generally greater than the number of inlet ports associated therewith. The number of inlet ports of the second laminate (and each succeeding laminate) preferably corresponds to the number (and spatial arrangement) of outlet ports from the immediately-preceding laminate. Using the system and geometric configuration shown herein, each additional plate would increase the number of outlets six times. However, some base number of openings other than six may be used. More generally, the number of outlet ports in the lowest plate is equal to the number of outlet ports in the uppermost plate raised to a power equal to the total number of plates. However, it is to be understood that other arrangements and numbers of outlet ports are envisioned without departing from the scope of the present invention.

Referring again to FIGS. 2A-2C the handling of a single liquid sample plug S is shown. In FIG. 2A, the sample plug S is passing through the capillary 25 toward the column 9. Different sample plugs S are separated on either side by the mobile phase liquid, as is known in the art. A given liquid sample S passes through the first closure 15 to the distributor 18. The flow of the sample S through the distributor 18 is schematically illustrated in FIG. 2B. The sample passes in a single stream through the opening 55 in the upper gasket 43 to the inlet port 53 of the first plate 39. The flow is divided into the three channels 47 emanating from the inlet port and further divided into two branches 47A at the end of the channels to the outlet ports 49 of the first plate 39. At the six outlet ports 49, the liquid sample passes through the first plate 39 to the inlet ports 63 of the second plate 41. The liquid sample is directed there to three channels 57 from each inlet port 63, or 18 total channels. The ends of the channels 57 have two branches 57A leading to respective ones of the 36 outlet ports 59. A fewer number of outlet ports 49, 59 in both the first and second plates 39, 41 have been illustrated in FIG. 2B for clarity. The representation of FIG. 2B is schematic and not intended to comport with the actual construction of the distributor 18. The liquid sample S exits the distributor 18 by passing through the openings 65 in the lower gasket 45. As shown in FIG. 2C, the sample S has been converted by the distributor 18 from a cylindrical stream to a thin, flat disk within the packing 27, having a diameter which is substantially the same as the internal cross sectional diameter of the tube 13. Thus, the packing 27 is given the best opportunity to separate the liquid sample S into its components for analysis by the detector 11.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than those listed.

As various changes could be made in the above constructions without departing from the scope of the invention, it is intended that all matter contained in the above description or shown in the accompanying drawings shall be interpreted as illustrative and not in a limiting sense. In view of the above, it will be seen that the several objects of the invention are achieved and other advantageous results attained.

What is claimed is:

1. A chromatographic column comprising:
a tube having first and second open ends;
packing disposed in the tube and substantially filling the tube between the ends;
first and second closures located at the first and second ends of the tube, respectively, the closures having passages for receiving a sample volume of liquid therethrough;
a distributor located in the tube generally adjacent to the first closure and between the passage in the first closure and the packing at the first end, the distributor including a first member disposed to receive liquid from the passage of the first closure, the first member having channels and outlet ports therein, and a second member disposed between the first member and the packing for receiving liquid from the outlets of the first member, the second member having channels and outlet ports therein, the number of outlet ports in the second member being greater than the number of outlet ports in the first member so that liquid of a liquid sample is distributed over a wider area into the packing, the channels in the second member being arranged to direct liquid from the outlet ports of the first member to the outlet ports of the second member.

2. A chromatographic column as set forth in claim 1 wherein the total volume of the channels in each of the first and second members is less than the sample volume.

3. A chromatographic column as set forth in claim 2 wherein the total volume of the channels in each of the first and second members is less than about 10 microliters.

4. A chromatographic column as set forth in claim 3 wherein the total volume of the channels in each of the first and second members is less than about 5 microliters.

5. A chromatographic column as set forth in claim 4 wherein the total volume of the channels in each of the first and second members is about 1 microliter.

6. A chromatographic column as set forth in claim 1 wherein the channels of the first member define flow paths for liquid extending from a location of entry of the liquid sample from the passage into the channels of the first member to the outlet ports, the flow paths each having a length which is substantially equal, and wherein the channels of the second member define flow paths for liquid extending from locations of entry of the liquid sample from the outlet ports of the first member into the channels of the second member to the outlet ports of the second member, the flow paths each having a length which is substantially equal.

7. A chromatographic column as set forth in claim 1 wherein the number of outlet ports in the second member is a multiple of the number of outlet ports in the first member.

8. A chromatographic column as set forth in claim 7 wherein the number of outlet ports in the second member is the square of the number of outlet ports in the first member.

9. A chromatographic column as set forth in claim 1 wherein the ratio of the width of the column to its height is between 0.01 and 3.

10. A chromatographic column as set forth in claim 9 wherein the ratio of the width of the column to its height is between 0.1 and 1.

11. A chromatographic column as set forth in claim 1 wherein the channels of the first member are formed in a first face of the first member and the channels of the second member are formed in a first face of the second member, and wherein the distributor further comprises a gasket engaging the first face of the first member and sealing the channels to prevent liquid in the channels from leaving the channels except through the outlet ports, the gasket having an opening therein for passing liquid from the passage through the gasket into the channels of the first member.

12. A chromatographic column as set forth in claim 11 wherein the gasket constitutes a first gasket and the distributor further comprises a second gasket engaging a second face of the second member opposite the first face, the second gasket having openings for passing liquid from the outlet ports of the second member to the packing.

13. A liquid distributor for use in distributing a small sample volume of liquid over an area in a chromatographic column, the distributor comprising a first thin, flat plate having multiple channels and outlet ports therein, the channels extending across the first plate to the outlet ports for delivering the sample volume to the outlet ports, the number of outlet ports in the second plate being greater than the number of outlet ports in the first plate so that liquid of the liquid sample is distributed over a wider area into the packing, the channels in the second plate being arranged to direct liquid from the outlet ports of the first plate to the outlet ports of the second plate

14. A liquid distributor as set forth in claim 13 wherein the total volume of the channels in said at least one plate is less than about 10 microliters.

15. A liquid distributor as set forth in claim 14 wherein the total volume of the channels in said at least one plate is about 1 microliter.

16. A liquid distributor as set forth in claim 13 wherein the channels of the plate define flow paths for liquid extending from a location of entry of the liquid sample into the channels to the outlet ports, the flow paths each having a length which is substantially equal, and wherein the channels of the second plate define flow paths for liquid extending from locations of entry of the liquid sample from the outlet ports of the first plate into the channels of the second plate to the outlet ports of the second plate, the flow paths each having a length which is substantially equal.

17. A liquid distributor as set forth in claim 13 wherein the number of outlet ports in the second plate is a multiple of the number of outlet ports in the first plate.

18. A liquid distributor as set forth in claim 17 wherein the number of outlet ports in the second plate is the square of the number of outlet ports in the first plate.

19. A liquid distributor as set forth in claim 13 wherein the channels of the first plate are formed in a first face of the first plate and the channels of the second plate are formed in a first face of the second plate, and wherein the distributor further comprises a gasket engaging the first face of the first plate and sealing the channels to prevent liquid in the channels from leaving the channels except through the outlet ports, the gasket including an opening for passing liquid into the channels of the first plate.

20. A liquid distributor as set forth in claim 19 wherein the gasket constitutes a first gasket and the distributor further comprises a second gasket engaging a second face of the second plate opposite the first face, the second gasket having openings for passing liquid from the outlet ports of the second plate through the second gasket.

21. A liquid chromatography system for identifying at least one property of a sample liquid volume comprising:
a liquid delivery device for delivering a volume of a liquid sample at a selected rate;
a column having packing therein for receiving the liquid sample;
a distributor in the column to distribute the sample liquid volume substantially over the cross sectional area of the column, the distributor having a thin flat plate including channels and outlet ports therein, the total volume of the channels in the plate being less than about 1/20th of the volume of the liquid sample;
a detector for detecting at least one property of liquid from the column;
the liquid delivery device being adapted to move the sample liquid volume through the column at the rate of at least about 2 cm/min.

22. A liquid chromatography system as set forth in claim 21 wherein the total volume of the channels in the plate is less than about 1/80th of the volume of the liquid sample volume.

23. A liquid chromatography system as set forth in claim 22 wherein the total volume of the channels in the plate is less than about 1/100th of the volume of the liquid sample volume.

24. A liquid chromatography system as set forth in claim 21 wherein the channels of the plate define flow paths for liquid extending from a location of entry of the liquid sample from the passage into the channels of the plate to the outlet ports, the flow paths each having a length which is substantially equal.

25. A liquid chromatography system as set forth in claim 24 wherein the plate constitutes a first plate and wherein the distributor further comprises a second thin, flat plate having channels and outlet ports therein, the second plate being disposed for receiving liquid from the outlet ports of the first plate, the channels of the second plate defining flow paths for liquid extending from locations of entry of the liquid sample from the outlet ports of the first plate into the channels of the second plate to the outlet ports of the second plate, the flow paths each having a length which is substantially equal.

26. A liquid chromatography system as set forth in claim 21 wherein the plate constitutes a first plate and wherein the distributor further comprises a second thin, flat plate having channels and outlet ports therein, and wherein the number of outlet ports in the second plate is a multiple of the number of outlet ports in the first plate.

27. A liquid chromatography system as set forth in claim 26 wherein the number of outlet ports in the second plate is the square of the number of outlet ports in the first plate.

28. A liquid chromatography system as set forth in claim 21 wherein the ratio of the width of the column to its height is between 0.01 and 3.

29. A liquid chromatography system as set forth in claim 28 wherein the ratio of the width of the column to its height is between 0.1 and 1.

30. A liquid chromatography system as set forth in claim 26 wherein the plate constitutes a first plate and wherein the distributor further comprises a second thin, flat plate having channels and outlet ports therein, the second plate being disposed for receiving liquid from the outlet ports of the first plate, wherein the channels of the first plate are formed in a first face of the first plate and the channels of the second plate are formed in a first face of the second plate, and wherein the distributor further comprises a gasket engaging the first face of the first plate and sealing the channels to prevent liquid in the channels from leaving the channels except through the outlet ports, the gasket having an opening for passing liquid into the channels of the first plate.

31. A liquid chromatography system as set forth in claim 30 wherein the gasket constitutes a first gasket and the distributor further comprises a second gasket engaging a second face of the second plate opposite the first face, the second gasket having openings for passing liquid from the outlet ports of the second plate into the packing.

32. A method of characterizing a liquid in a flow analysis system comprising the steps of:
delivering a sample liquid in a volume to a column;
conducting the sample liquid volume in channels on a surface of a thin, flat distributor plate to outlets on the plate, the channels having a total volume less than about 1/20th the sample liquid volume, the sample liquid volume being dispersed over an area within the column by the distributor plate;
passing the liquid sample volume from the distributor plate into a separation medium in the column;
analyzing the effluent of the liquid sample from the column to determine a property of the liquid sample.

33. A method of characterizing a liquid in flow as set forth in claim 32 wherein said step of delivering a sample liquid comprises delivering a sample liquid composed of macromolecules.

34. A method of characterizing a liquid in flow as set forth in claim 32 wherein said step of conducting the liquid sample comprises directing liquid in the channels of the distributor plate to outlet ports in the distributor plate arranged over a first area, passing liquid from the outlet ports of the first plate to channels in a second plate, the channels of the second plate leading to outlet ports in the second plate arranged over an area greater than the area of the outlet ports in the first plate.

35. A method of characterizing a liquid in flow as set forth in claim 32 wherein the step of delivering liquid includes delivering liquid at a rate of at least 2 cm/min.

36. A method of characterizing a liquid in flow as set forth in claim 35 wherein the step of delivering liquid includes delivering liquid at a rate of about 5 cm/min.

37. A method of characterizing a liquid in flow as set forth in claim 30 wherein the total volume of the channels in the distributor plate is less than about 1/80th the volume of the liquid sample.

38. A method of characterizing a liquid in flow as set forth in claim 35 wherein the total volume of the channels in the distributor plate is less than about 1/100th the volume of the liquid sample.
